(19) United States
(12) Patent Application Publication
(10) Pub. No.: US 2011/0291978 A1
(43) Pub. Date: Dec. 1, 2011

(54) Touch Display Panel and Manufacturing Method Thereof

(75) Inventors: Kun-Chang Ho, Taichung City (TW); Chih-Chang Lai, Taiping City (TW); Hsiao-Hui Liao, Taichung City (TW)

(73) Assignees: WINTEK CORPORATION, Taichung City (TW); DONGGUAN MASSTOP LIQUID CRYSTAL DISPLAY CO., LTD., Dongguan City (CN)

(21) Appl. No.: 13/149,266

(22) Filed: May 31, 2011

(30) Foreign Application Priority Data
May 31, 2010 (TW) 99117474

(51) Int. Cl. G06F 3/041; B32B 37/00

(52) U.S. Cl. 345/173; 156/182

(57) ABSTRACT

A touch display panel and a manufacturing method thereof are provided. The touch display panel includes a PCB, a display panel, a touch panel, a first conductive adhesive and a second conductive adhesive. The touch panel, electrically connected to the PCB, includes a substrate and a plurality of signal traces. The substrate includes a plurality of first signal pads and a plurality of second signal pads. The first signal pads correspond to a first edge of the substrate, and the second signal pads correspond to a second edge of the substrate. Each of the signal traces, disposed on the substrate and used for transmitting a touch signal, is electrically connected to one of the first signal pads or one of the second signal pads. The first conductive adhesive electrically connects the first signal pads and the PCB. The second conductive adhesive electrically connects the second signal pads and the PCB.

This application claims the benefit of Taiwan application Serial No. 99117474, filed May 31, 2010, the subject matter of which is incorporated herein by reference.

### BACKGROUND OF THE INVENTION

1. Field of the Invention

The invention relates to a touch display panel with lots of signal pads and a manufacturing method thereof.

2. Description of the Related Art

A touch panel basically includes a plurality of sensing traces, traces and pads. The signal traces electrically connect the sensing traces and the signal pads.

In general, the signal pads are disposed on the same side of the touch panel, and the signal traces are disposed in a limited space, so the complexity in design is increased. Moreover, due to the restriction in the position of the signal pads, the signal traces have big difference in terms of length, and the sensing precision is affected.

### SUMMARY OF THE INVENTION

The invention is directed to a touch display panel and a manufacturing method thereof. The signal pads are disposed on two different edges of the substrate. The signal traces can be connected to the signal pads via a path with suitable length, so that the difference in the length of the path between two signal traces is reduced or the path length of each signal trace becomes shortest so as to increase the precision in the sensing of the touch panel

According to a first aspect of the present invention, a touch display panel is provided. The touch display panel includes a printed-circuit board (PCB), a display panel, a touch panel, a first conductive adhesive and a second conductive adhesive. The display panel is electrically connected to the PCB. The touch panel is electrically connected to the PCB and includes a substrate and a plurality of signal traces. The substrate includes a plurality of first signal pads and a plurality of second signal pads, wherein the first signal pads correspond to a first edge of the substrate, and the second signal pads correspond to a second edge of the substrate. The signal traces are disposed on the substrate and used for transmitting a touch signal. Each signal trace is electrically connected to one of the first signal pads or one of the second signal pads. The first conductive adhesive electrically connects the first signal pads and the PCB. The second conductive adhesive electrically connects the second signal pads and the PCB.

According to a second aspect of the present invention, a manufacturing method of touch display panel is provided. The manufacturing method includes the following steps. Firstly, a touch panel including at least a substrate, which includes at least a substrate, is provided. The at least a substrate includes a plurality of first signal pads, a plurality of second signal pads, and a plurality of signal traces, wherein the first signal pads correspond to a first edge of the substrate, the second signal pads correspond to a second edge of the substrate, the signal traces are used for transmitting a touch signal, and each signal trace is electrically connected to one of the first signal pads or one of the second signal pads. Next, a display panel and a PCB are provided. Then, the touch panel is disposed on the display panel. Afterwards, the first signal pads and the PCB are electrically connected by a first conductive adhesive, and the second signal pads and the PCB are electrically connected by a second conductive adhesive.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a according to a top view of a touch display panel according to a first embodiment of the invention;

FIG. 2 shows a cross-sectional view along the direction 2-2′ of FIG. 1;

FIG. 3 shows a manufacturing process of a touch display panel according to a first embodiment of the invention;

FIG. 4 shows a according to a top view of a touch display panel according to a second embodiment of the invention;

FIG. 5 shows a according to a top view of a touch display panel according to a third embodiment of the invention; and

FIG. 6 shows a cross-sectional view along the direction 6-6′ of FIG. 5.

### DETAILED DESCRIPTION OF THE INVENTION

### First Embodiment

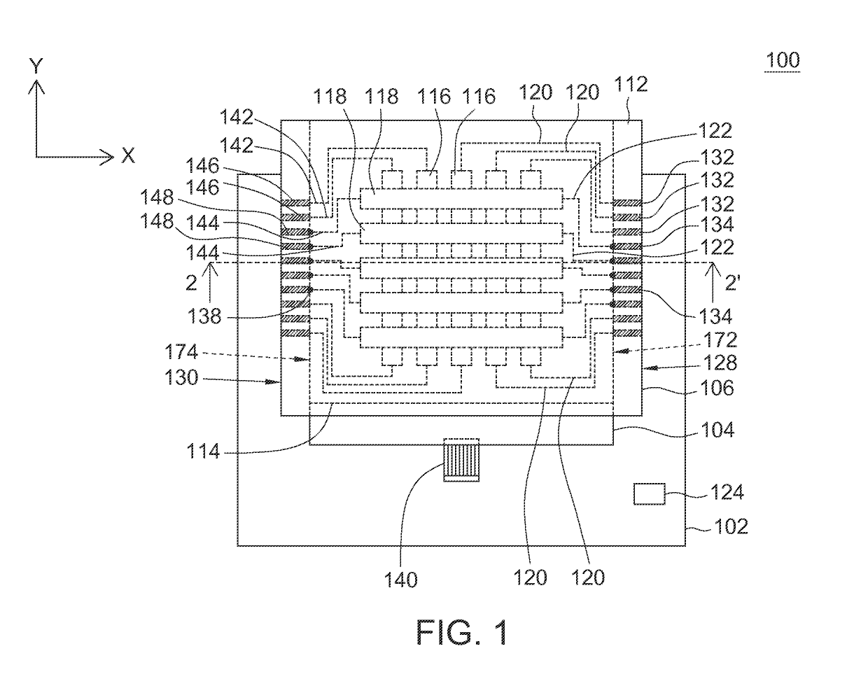

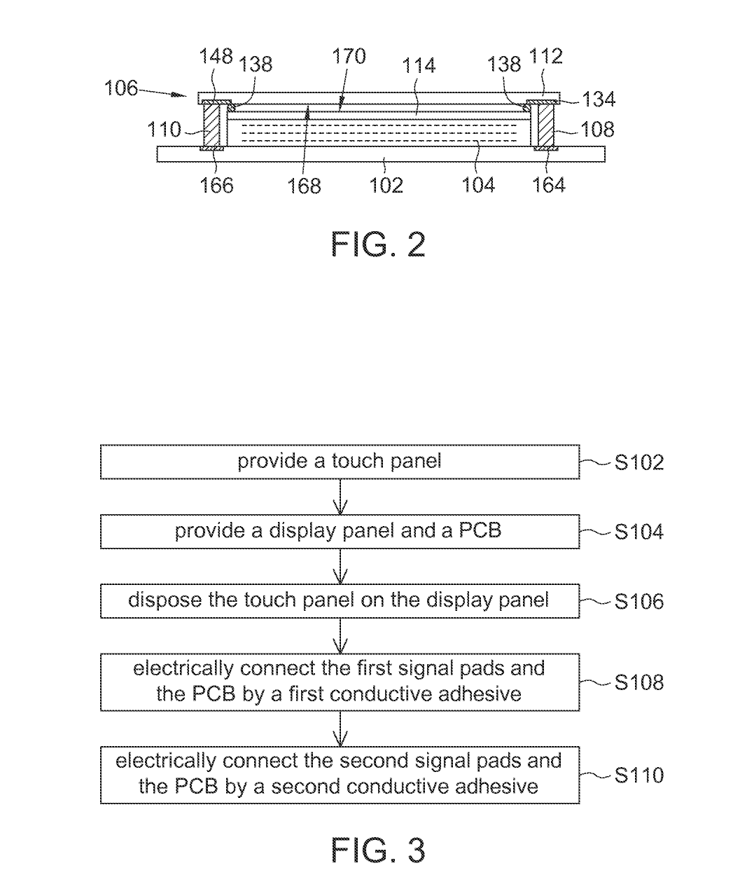

Referring to FIG. 1 and FIG. 2. FIG. 1 shows a according to a top view of a touch display panel according to a first embodiment of the invention. FIG. 2 shows a cross-sectional view along the direction 2-2′ of FIG. 1

As indicated in FIG. 1, the touch display panel 100 includes a printed-circuit board (PCB) 102, a display panel 104, a touch panel 106, a first conductive adhesive 108 and a second conductive adhesive 110 (the first conductive adhesive 108 and the second conductive adhesive 110 are illustrated in FIG. 2). The touch panel 106 is realized by a resistive touch panel.

The touch panel 106 includes a plurality of signal traces, a first substrate 112 and a second substrate 114. The first substrate 112 and the second substrate 114 are opposite to each other. The signal traces include a plurality of first signal traces 120, a plurality of second signal traces 122, a plurality of third signal traces 142 and a plurality of fourth signal traces 144.

The first substrate 112 includes a plurality of first sensing traces 116, a plurality of first signal pads and a plurality of second signal pads. The first signal pads include a plurality of first sub-signal pads 132 and a plurality of second sub-signal pads 134. The second signal pads include a plurality of third sub-signal pads 146 and a plurality of fourth sub-signal pads 148.

The first sensing traces 116, the first signal pads, the second signal pads, the first signal traces 120 and the third signal traces 142 are all disposed on a first surface 168 (illustrated in FIG. 2) of the first substrate 112. The second substrate 114 includes a plurality of second sensing traces 118. The second sensing traces 118, the second signal traces 122 and the fourth signal traces 144 are all disposed on a second surface 170 (illustrated in FIG. 2) of the second substrate 114.

The first sub-signal pads 132 and the second sub-signal pads 134 correspond to a first edge 128 of the first substrate 112. The third sub-signal pads 146 and the fourth sub-signal pads 148 correspond to a second edge 130 of the first substrate 11. The first edge 128 and the second edge 130 are two opposite edges of the first substrate 112.

The first sensing traces 116 are arranged along the Y-axis direction, and the second sensing traces 118 are arranged along the X-axis direction. The first sensing traces 116 and the second sensing traces 118 form a sensing region of the touch panel 106. The first signal traces 120, the second signal traces 122, the third signal traces 142 and the fourth signal traces 144 are used for transmitting a touch signal (not illustrated) of the sensing region.

In the present embodiment of the invention, the first signal pads and the second signal pads are respectively disposed on two different edges of the first substrate 112, so that the first signal traces 120, the second signal traces 122, the third signal traces 142 and the fourth signal traces 144 can be selectively connected to the first signal pads (that is, the first sub-signal pads 132 and the second sub-signal pads 134) or the second signal pads (that is, the third sub-signal pads 146 and the fourth sub-signal pads 148) via a path with suitable length, hence reducing the difference in path length of two signal traces or minimizing the path length of each signal trace so as to increase the sensing accuracy of the touch panel 106.

In the present embodiment of the invention, the first sub-signal pads 132 and the second sub-signal pads 134 are adjacent to the first edge 128 of the first substrate 112 as illustrated in FIG. 1, but such exemplification is not for limiting the invention. In other implementations, the first sub-signal pads 132 and the second sub-signal pads 134 can be separated by from the first edge 128 by a distance. Similarly, the third sub-signal pads 146 and the fourth sub-signal pads 148 can also be separated from the second edge 130 by a distance.

In the above exemplification, the first sensing traces 116 are disposed on the first substrate 112 and the second sensing traces 118 are disposed on the second substrate 114, but such exemplification is not for limiting the invention. In other implementations, either of the first sensing traces 116 and the second sensing traces 118 can be selectively disposed on the first substrate 112 or the second substrate 114 according to the type of the touch panel and the needs of the design. The invention does not impose any restrictions regarding the disposition of the first sensing traces 116 and the second sensing traces 118.

The connection relationships among the first signal traces 120, the second signal traces 122, the first sensing traces 116, the second sensing traces 118 and the first signal pads are disclosed below.

The first signal traces 120 of the first substrate 112 electrically connect the first sub-signal pads 132 of the first substrate 112 and the first sensing traces 116 of the first substrate 112, but such exemplification is not for limiting the invention. In an implementation, if the first sensing traces 116 and the second sensing traces 118 are both formed on the first substrate 112, then the first signal traces 120 can be selectively and electrically connected to the second sensing traces 118 of the first substrate 112.

One end of the second signal traces 122 of the second substrate 114 is extended to be near the first edge 172 of the second substrate 114, and is electrically connected to the second sub-signal pads 134 of the first substrate 112 through the substrate conductive adhesive 138, and the other end of the second signal traces 122 is electrically connected to the second sensing traces 118 of the second substrate 114, but such exemplification is not for limiting the invention. In an implementation, if the first sensing traces 116 and the second sensing traces 118 are both formed on the second substrate 112, then the second signal traces 122 can be selectively and electrically connected to the first sensing traces 116 of the second substrate 114. Furthermore, the first edge 172 of the second substrate 114 and the first edge 128 of the first substrate 112 are on the same side.

In addition, the third signal traces 142 of the first substrate 112 electrically connect the third sub-signal pads 146 of the first substrate 112 and the first sensing traces 116 of the first substrate 112.

One end of the fourth signal traces 144 of the second substrate 114 is extended to be near a second edge 174 of the second substrate 114 and electrically connected to the fourth sub-signal pads 148 of the first substrate 112 through the substrate conductive adhesive 138, and the other end of the fourth signal traces 144 is electrically connected to the second sensing traces 118 of the second substrate 114. The second edge 174 of the second substrate 114 and the second edge 130 of the first substrate 112 are on the same side.

The substrate conductive adhesive 138 of FIG. 2 can be realized by conductive particles or epoxy.

Referring to FIG. 2, the first conductive adhesive 108, such as a conductive rubber, connects the first signal pads (that is, the first sub-signal pads 132 and the second sub-signal pads 134) and the PCB 102. The second conductive adhesive 110, such as a conductive rubber, connects the second signal pads (that is, the third sub-signal pads 146 and the fourth sub-signal pads 148) and the PCB 102. In comparison to the design of traces of a flexible printed circuit board (FPC), the way of electrically connecting the first substrate 112 and the second substrate 114 by a conductive adhesive (that is, the first conductive adhesive 108 and the second conductive adhesive 110) can do without flexible cable and cable connector that are required by a FPC, saving the cost and labor required for arranging the flexible cables.

As indicated in FIG. 2, the PCB 102 includes a plurality of first PCB pads 164 (only one is illustrated in FIG. 2), a plurality of second PCB pads 166 (only one is illustrated in FIG. 2) and a control chip 124 (illustrated in FIG. 1). The first conductive adhesive 108 vertically conducts the first signal pads (that is, the first sub-signal pads 132 and the second sub-signal pads 134) and the first PCB pads 164, the second conductive adhesive 110 vertically conducts the second signal pads (that is, the third sub-signal pads 146 and the fourth sub-signal pads 148) and the second PCB pads 166. The control chip 124 is electrically connected to the first PCB pads 164 and the second PCB pads 166 for processing a touch signal.

Also, the touch display panel 100 further includes an FCB 140 (illustrated in FIG. 1), which electrically connects the PCB 102 and the display panel 104 and is used for transmitting the signals among the touch panel 106, the display panel 104 and the PCB 102.

In the present embodiment of the invention, the first edge 128 and the second edge 130 of the first substrate are two opposite edges of the first substrate. However, in other implementations, the first edge and the second edge can be two adjacent edges of the first substrate.

In an implementation, the touch display panel 100 further includes an outer frame (not illustrated) at least surrounding the touch panel 106 and the display panel 104 to protect the touch panel 106 and the display panel 104.

The manufacturing method of the touch display panel of the invention is exemplified by the touch display panel 100. Referring to FIG. 3, a manufacturing process of a touch display panel according to a first embodiment of the invention is shown.

In step S102, a touch panel 106 is provided.

In other implementations, before step S102 of providing the touch panel 106, the manufacturing method further includes the following steps: Firstly, a first substrate 112 and a second substrate 114 are provided, wherein the first substrate 112 includes a plurality of first sensing traces 116, and the second substrate 114 includes a plurality of second sensing traces 118. Next, a plurality of first sub-signal pads 132 and a plurality of second sub-signal pads 134 are formed on the first substrate 112. Then, a plurality of third sub-signal pads 146 and a plurality of fourth sub-signal pads 148 are formed on the first substrate 112. Afterwards, a plurality of first signal traces 120 and a plurality of third signal traces 142 are formed on the first substrate 112, and a plurality of second signal traces 122 and a plurality of fourth signal traces 144 are formed on the second substrate 114. Thus, the touch panel 106 is formed.

Next, in step S104, the display panel 104 and PCB 102 as illustrated in FIG. 1 are provided.

Then, in step S106, the touch panel 106 is disposed on the display panel 104.

Afterwards, in step S108, the first signal pads and the first PCB pads 164 of the PCB 102 are electrically connected by a first conductive adhesive 108.

Then, in step S110, the second signal pads and the second PCB pads 166 of the PCB 102 are electrically connected by a second conductive adhesive 110. Thus, the touch display panel 100 is formed.

### Second Embodiment

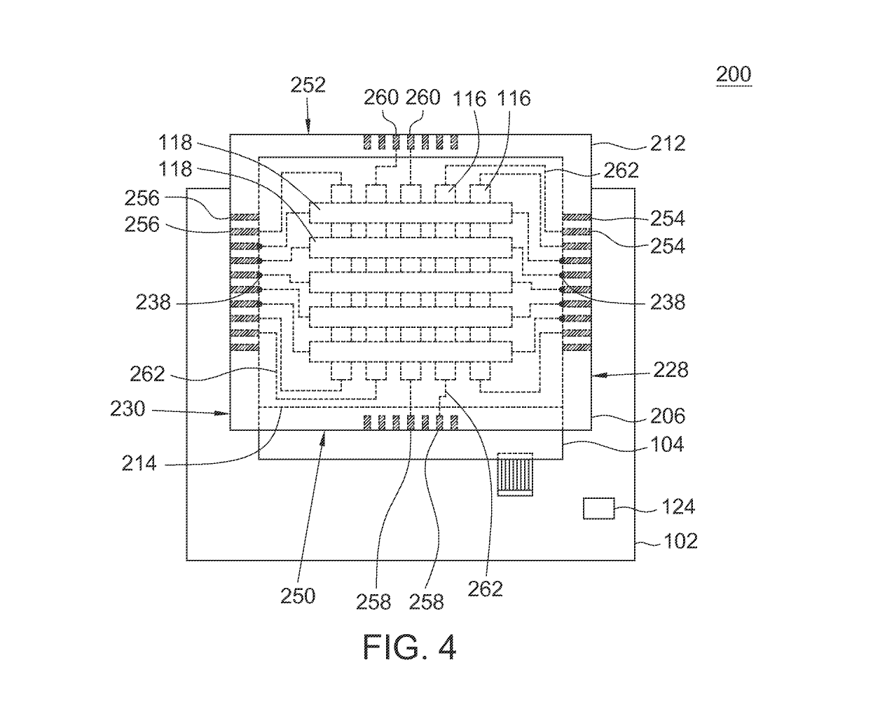

Referring to FIG. 4, a according to a top view of a touch display panel according to a second embodiment of the invention is shown. As for the similarities between the second embodiment and the first embodiment, the same designations are used and the similarities are not repeated here. The touch display panel 200 of the second embodiment is different from the touch display panel 100 of the first embodiment in that the signal pads of the touch display panel 200 correspond to four edges of the first substrate.

The touch panel 206 of the touch display panel 200 is realized by a resistive touch panel, which includes a plurality of signal traces 262, a first substrate 212 and a second substrate 214, wherein the signal traces 262 are disposed on the first substrate 212 and the second substrate 214.

The first substrate 212 includes a plurality of first sensing traces 116, a plurality of first signal pads 254, a plurality of second signal pads 256, a plurality of third signal pads 258 and a plurality of fourth signal pads 260. The first signal pads 254, the second signal pads 256, the third signal pads 258 and the fourth signal pads 260 respectively correspond to the first edge 228, the second edge 230, the third edge 250 and the fourth edge 252 of the first substrate 212. The first edge 228 and the second edge 230 are two opposite edges of the first substrate 212, and the third edge 250 and the fourth edge 252 are the other two opposite edges of the first substrate 212.

Besides, the second substrate 214 includes a plurality of second sensing traces 118. A portion of the signal traces 262 can be formed on the first substrate 212, and the other portion can be formed on the second substrate 214. The signal traces 262 of the first substrate 212 can be selectively and electrically connected to the first signal pads 254, the second signal pads 256, the third signal pads 258 or the fourth signal pads 260 of the first substrate 212. The signal traces 262 of the second substrate 214 are correspondingly and electrically connected to the first signal pads 254, the second signal pads 256, the third signal pads 258 or the fourth signal pads 260 of the first substrate 212 through the substrate conductive adhesive 238.

Since there are many paths between the signal traces 262 and the signal pads (that is, the first signal pads 254, the second signal pads 256, the third signal pads 258 or the fourth signal pads 260), the difference in the length of the path between any two signal traces 262 is reduced or the path length of each signal trace is minimized so as to increase the precision in the sensing of the touch panel 206.

In addition, the third conductive adhesive electrically connects the third signal pads 258 and the PCB 102, and the fourth conductive adhesive electrically connects the fourth signal pads 260 and the PCB 102.

Both the step of electrically connecting the third signal pads 258 and the PCB 102 with the third conductive adhesive and the step of electrically connecting the fourth signal pads 260 and the PCB 102 with the fourth conductive adhesive can be performed after the step S106 of FIG. 3.

### Third Embodiment

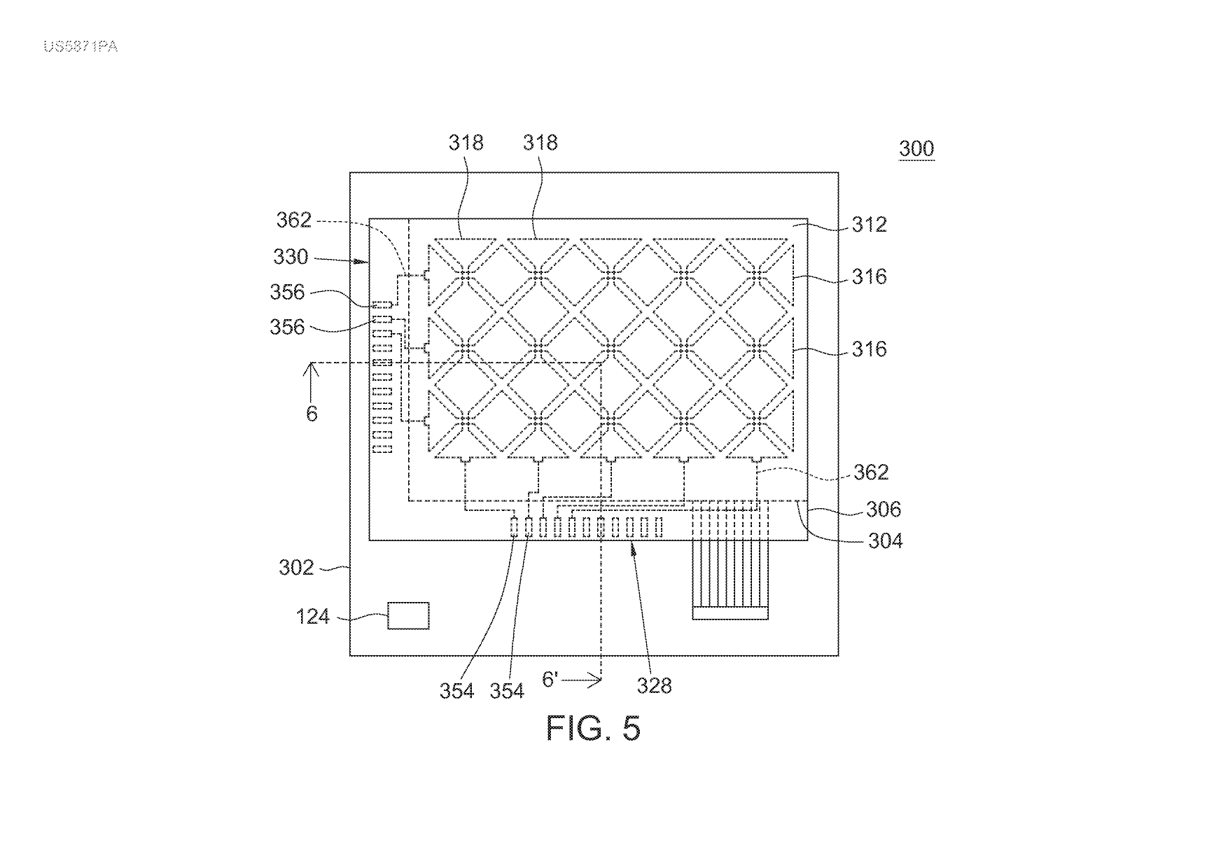

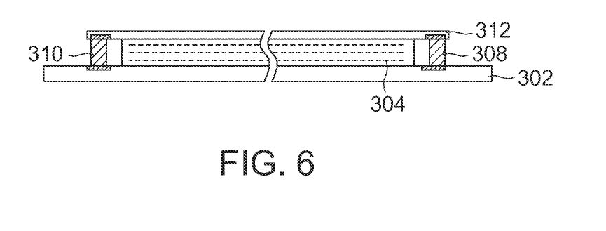

Referring to FIG. 5 and FIG. 6. FIG. 5 shows a according to a top view of a touch display panel according to a third embodiment of the invention. FIG. 6 shows a cross-sectional view along the direction 6-6′ of FIG. 5. As for the similarities between the third embodiment and the first embodiment, the same designations are used and the similarities are not repeated here. The touch display panel 300 of the third embodiment is different from the touch display panel 100 of the first embodiment in that the sensing traces of the touch panel 306 of the touch display panel 300 are formed in a single substrate.

The touch panel 306 is realized by a capacitive touch panel, which includes a plurality of signal traces 362 and a substrate 312. The substrate 312 includes a plurality of first sensing traces 316 and a plurality of second sensing traces 318. The first sensing traces 316, the second sensing traces 318 and the signal traces 362 are all formed on the substrate 312.

The substrate 312 includes a plurality of first signal pads 354 and a plurality of second signal pads 356. The first signal pads 354 correspond to the first edge 328 of the substrate 312. The second signal pads 356 correspond to the second edge 330 of the substrate 312. The first edge 328 and the second edge 330 are two adjacent edges of the substrate 312.

Each signal trace 362 can be selectively and electrically connected to the first signal pads 354 or the second signal pads 356, so that the difference in the length of the path between two signal traces is reduced or the path length of each signal trace is minimized so as to increase the precision in the sensing of the touch panel 306.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A touch display panel, comprising:
a printed-circuit board (PCB);
a display panel electrically connected to the PCB;
a touch panel electrically connected to the PCB, wherein the touch panel comprises:
at least a substrate comprising a plurality of first signal pads and a plurality of second signal pads, wherein the first signal pads are disposed corresponding to a first edge of the at least a substrate, and the second signal pads are disposed corresponding to a second edge of the at least a substrate; and
a plurality of signal traces disposed on the at least a substrate and used for transmitting a touch signal, wherein each signal trace is electrically connected to one of the first signal pads or one of the second signal pads; and
a first conductive adhesive and a second conductive adhesive, wherein the first conductive adhesive electrically connects the first signal pads and the PCB, and the second conductive adhesive electrically connects the second signal pads and the PCB.

2. The touch display panel according to claim 1, wherein the at least a substrate further comprises:
a plurality of third signal pads disposed corresponding to a third edge of the at least a substrate;
wherein, each signal trace is electrically connected to one of the first signal pads, one of the second signal pads or one of the third signal pads, and the touch display panel further comprises a third conductive adhesive, which electrically connects the third signal pads and the PCB.

3. The touch display panel according to claim 2, wherein the at least a substrate further comprises:
a plurality of fourth signal pads disposed corresponding to a fourth edge of the at least a substrate;
wherein, each signal trace is electrically connected to one of the first signal pads, one of the second signal pads, one of the third signal pads or one of the fourth signal pads;
wherein, the touch display panel further comprises a fourth conductive adhesive, which electrically connects the fourth signal pads and the PCB.

4. The touch display panel according to claim 1, wherein the at least a substrate comprises:
a first substrate and a second substrate opposite to the first substrate, wherein some of the signal traces, the first signal pads and the second signal pads are disposed on the first substrate, the first signal pads are disposed corresponding to a first edge of the first substrate, the second signal pads are disposed corresponding to a second edge of the first substrate, the signal traces are electrically connected to the first signal pads and the second signal pads, the first edge of the first substrate and the first edge of the second substrate are located at the same side of the touch panel, and the second edge of the first substrate and the second edge of the second substrate are located at another side of the touch panel;
wherein, the touch panel further comprises a plurality of substrate conductive adhesives disposed between the first substrate and the second substrate, the signal traces are electrically connected to the first signal pads and the second signal pads through the substrate conductive adhesives.

5. The touch display panel according to claim 1, wherein the PCB comprises:
a plurality of first PCB pads and a plurality of second PCB pads, wherein the first conductive adhesive electrically connects the first signal pads and the first PCB pads, and the second conductive adhesive electrically connects the second signal pads and the second PCB pads; and
a control chip electrically connected to the first PCB pads and the second PCB pads and used for processing the touch signal.

6. A manufacturing method of touch display panel, comprising:
providing a touch panel comprising at least a substrate, which comprises a plurality of first signal pads, a plurality of second signal pads, a plurality of signal traces, wherein the first signal pads are disposed corresponding to a first edge of the at least a substrate, the second signal pads are disposed corresponding to a second edge of the at least a substrate, the signal traces are used for transmitting a touch signal, and each signal trace is electrically connected to one of the first signal pads or one of the second signal pads;
providing a display panel and a PCB;
disposing the touch panel on the display panel;
electrically connecting the first signal pads and the PCB by a first conductive adhesive; and
electrically connecting the second signal pads and the PCB by a second conductive adhesive.

7. The manufacturing method according to claim 6, wherein before the step of providing the touch panel, the manufacturing method further comprises:
forming the touch panel, comprising:
providing the at least a substrate;
forming the first signal pads at a first edge of the at least a substrate;
forming the second signal pads at a second edge of the at least a substrate; and
forming the signal traces on the at least a substrate.

8. The manufacturing method according to claim 7, wherein the step of forming the touch panel further comprises:
forming a plurality of third signal pads on the at least a substrate, wherein the third signal pads correspond to a third edge of the at least a substrate; and
forming a plurality of fourth signal pads on the at least a substrate, wherein the fourth signal pads correspond to a fourth edge of the at least a substrate;
wherein, in the step of forming the signal traces on the at least a substrate, each signal trace is electrically connected to one of the first signal pads, one of the second signal pads, one of the third signal pads or one of the fourth signal pads.

9. The manufacturing method according to claim 7, before the step of providing the at least a substrate, the manufacturing method further comprises:
forming the at least a substrate comprising:
providing a first substrate and a second substrate;
the step of forming the first signal pads further comprises:
forming a plurality of first sub-signal pads and a plurality of second sub-signal pads on the first substrate, wherein the first sub-signal pads and the second sub-signal pads correspond to a first edge of the first substrate;
the step of forming the signal traces further comprises:
forming a plurality of first signal traces on the first substrate, wherein the first signal traces are electrically connected to the first sub-signal pads; and
forming a plurality of second signal traces on the second substrate, wherein the second signal traces are extended adjacent to a first edge of the second substrate, and the first edge of the first substrate corresponds to the first edge of the second substrate; and
the step of forming the touch panel further comprises:
forming a plurality of substrate conductive adhesives between the first substrate and the second substrate for electrically connecting the second signal traces and the second sub-signal pads.

10. The manufacturing method according to claim 9, wherein the step of forming the second signal pads comprises:
forming a plurality of third sub-signal pads and a plurality of fourth sub-signal pads on the first substrate, wherein the third sub-signal pads and the fourth sub-signal pads correspond to the second edge of the first substrate;
the step of forming the signal traces further comprises:
forming a plurality of third signal traces on the first substrate, wherein the third signal traces are electrically connected to the third sub-signal pads; and
forming a plurality of fourth signal traces on the second substrate, wherein the fourth signal traces are extended adjacent to a second edge of the second substrate, and the second edge of the first substrate corresponds to the second edge of the second substrate;
wherein, in the step of forming the substrate conductive adhesives between the first substrate and the second substrate, the substrate conductive adhesives further electrically connects the fourth signal traces and the fourth sub-signal pads.

11. The manufacturing method according to claim 6, wherein the PCB comprises a plurality of first PCB pads, a plurality of second PCB pads and a the control chip, the control chip is electrically connected to the first PCB pads and the second PCB pads and used for processing the touch signal, and the step of electrically connecting the first signal pads and the PCB by the first conductive adhesive further comprises:
electrically connecting the first signal pads and the first PCB pads by the first conductive adhesive; and
the step of electrically connecting the second signal pads and the PCB by the second conductive adhesive further comprises:
electrically connecting the second signal pads and the second PCB pads by the second conductive adhesive.
